(19) United States
(12) Patent Application Publication
(10) Pub. No.: US 2004/0206682 A1
(43) Pub. Date: Oct. 21, 2004

(54) Filter assembly utilizing carbon block and pleated filter element

(76) Inventors: Thomas Hamlin, Vernon, CT (US); Martin Blaze, Hamden, CT (US); Laurence W. Bassett, Killingworth, CT (US)

Correspondence Address: CUNO INCORPORATED, 400 RESEARCH PARKWAY, P. O. BOX 1018, MERIDEN, CT, 06450-1018, US

(21) Appl. No.: 10/418,453

(22) Filed: Apr. 18, 2003

(51) Int. Cl. B01D 35/16

(52) U.S. Cl. 210/321.6; 210/321.86; 210/338; 210/493.3; 210/266

(57) ABSTRACT

A filter assembly for a filter cartridge is disclosed, the filter assembly including a generally cylindrical carbon block filter element and a generally cylindrical pleated filter element disposed around the radially outer surface of the carbon block filter element. The filter assembly has an outlet communicating with the axial cavity of the carbon block filter element, so that filtrate first passes through the pleated filter element, enters the carbon block filter element through its radially outer surface, propagates radially inwardly to the central cavity of the carbon block filter element and then axially along the central cavity of the carbon block filter element, and exits the central cavity of the carbon block filter element through the outlet.

### BACKGROUND OF THE INVENTION

1. Field of the Invention

The subject invention relates to a filtration device, and more particularly, to a filter assembly configured to be housed within a filter cartridge. The filter assembly according to the subject disclosure may include a carbon block filter element and a pleated filter element surrounding the radially outer surface of the carbon block filter element.

2. Background of the Related Art

In most areas of the world, drinking or tap water contains significant amounts of harmful or offensive chemicals, suspended particulate matter, and microorganisms. In a variety of circumstances, these contaminants must be removed before the water can be used. Although municipal water treatment plants attempt to address this problem, many individuals and organizations find such efforts insufficient and utilize on-site water filters. Frequently, such water filters are integrated into appliances, such as ice makers of refrigerators, or water dispensers.

Filter elements containing activated carbon are known to be effective in removing chemicals from water, e.g., chlorine, hydrogen sulfide, pesticides, herbicides, phenol, chlorophenol and hydrocarbon. Removal of such contaminants usually improves the taste, odor and appearance of the filtered water. Nonetheless, most carbonaceous filter elements are not fine enough to remove bacteria, viruses or other microorganisms. For that purpose, various microporous filter elements have been incorporated into filtration devices in addition to carbonaceous filter elements. Microporous filter elements known to be effective at removing bacteria, viruses, and other microorganisms include hollow microporous fibers, such as those described in the U.S. Pat. No. 3,526,001, microporous membranes, such as those described in the U.S. Pat. No. 6,113,784 (the disclosure of which is incorporated by reference herein), and other structures capable of performing equivalent functions.

U.S. Pat. No. 5,092,990 to Muramutsu et al. describes a filter device including a generally cylindrical casing and a filter element contained in the casing. According to one embodiment, the filter element includes a corrugated filter membrane and a support net in contact with the inner surface of the filter membrane. The corrugated membrane can be made of a filter cloth and shaped to have a generally cylindrical contour, with a pre-coat layer of activated carbon particles formed on the outer surface of the membrane. A hollow fiber unit is disposed within the support net. The water to be filtered enters the filter unit through the outer surface of the corrugated filter membrane, passes through the support net and, after traveling in the upward direction through the hollow fibers, exits the filter element through the central opening at the top.

The pre-coat design described in U.S. Pat. No. 5,092,990 has various disadvantages. For example, coating the outer surface of the membrane with a layer of activated carbon inhibits porosity of the membrane, so that the coated membrane becomes incapable of relatively coarse filtration. In addition, the pre-coat design may result in insufficient depth and non-uniform thickness of the carbon layer or, possibly, even in bare spots on the membrane.

U.S. Pat. No. 4,714,546 to Solomon et al. discloses a portable water filter having a water-impermeable tube within the filter's housing, a tubular pleated element surrounding the tube and an activated carbon filter located within the tube. In operation, a portion of the water from the inlet flows through the tubular pleated element and then through the carbon filter element to a second outlet. Another portion of the water from the inlet flows along the tubular pleated element to flush the tubular element and then flows out through a first outlet. The water that flows radially through the pleated element then enters the water-impermeable tube at the bottom opening and flows in the upward direction, eventually exiting through the second outlet at the top of the housing.

U.S. Pat. No. 4,828,698 to Jewell et al. discloses a filtering apparatus having a generally cylindrical filter arrangement, which includes a cylindrically shaped porous means, a cylindrically shaped sorbent-containing means and a cylindrically shaped microporous means. The microporous means is disposed downstream of the other two means. The microporous means may include a pleated porous nylon membrane, and the sorbent means may contain activated carbon. The filtrate entering through the axially-aligned inlet located at the top of the filtering apparatus is channeled toward the radially outer surface of the filter element. The fluid then flows radially inwardly through the different stages of the filter, into the central cavity of the filter element, and out through the axially aligned outlet at the bottom of the filtering apparatus.

U.S. Pat. No. 6,136,189 to Smith et al. discloses a filter assembly for use with a water bottle having a circular cross-section neck or open end, which may include a cylindrically-shaped pleated membrane arranged around an inner filtration media containing activated carbon. In operation, when the filter assembly is immersed in water filling a bottle, the water to be filtered enters through the perforations or slots in the filter's side walls, flows radially inwardly through the pleated membrane, through the inner filtration medium, and into the central space of the filter that communicates with the outlet. The pleated membranes for use in the filtering apparatus, described in U.S. Pat. No. 6,136,189, are not capable of retaining particles smaller than about 1 micron. The porosity of the inner, carbon-containing media is between about 10-150 microns. Further, the filter media remain immersed into and in direct contact with the water to be filtered. These structural shortcomings result in decreased efficiency of this filter and in the lack of quality of the resultant product.

U.S. Pat. No. 6,290,848 to Tanner et al. discloses a filter cartridge for a gravity-fed water treatment device, which contains a porous particulate filter, such as a pleated membrane, and granular media, such as carbon, disposed within the porous particulate filter. The granular media is disposed in the central volume of the filter. The water to be treated first flows into the interior volume of the filter, through the granular media, then radially outwardly through the porous particulate filter.

Despite the efforts to date, there remains a need in the field of fluid filtration for improved filter assemblies, as well as cartridges configured for housing such filter assemblies, that effectively and efficiently reduce both chemical contamination and microorganisms in a fluid stream, introduce a relatively low pressure drop, afford adequate filter life, and provide for consistent filtration quality relatively unaffected by the age of the filter or by ordinary handling of the filter unit. Although references discussed above disclose composite filter elements incorporated into filtration devices, they do not teach or suggest, alone or in combination, an advantageous filter assembly utilizing a carbon block filter element and a pleated filter element surrounding the radially outer surface of the carbon block filter element as described and claimed herein.

### SUMMARY OF THE INVENTION

The inventors of the present disclosure have resolved many of the problems associated with the filter assemblies described above by employing a filter assembly that may include a carbon block filter element to remove particulate matter and absorb chemical contaminants and a pleated filter element to remove microorganisms and/or particulate matter from the filtrate passing through this filter assembly. The filter assembly constructed in accordance with the subject disclosure has superior performance characteristics, such as capacity for effective removal of chemical contaminants, particulate matter and microorganisms, while maintaining relatively long life time and relatively low pressure drop.

Among the advantages of the filter assembly having a microporous filter element disposed upstream of the carbon block filter element is its capability of retaining microorganisms before they can enter the carbon block element where they can grow, multiply and eventually colonize the filter cartridge. In addition, when the carbon block element is located downstream of the microporous element, any undesirable odor or taste generated in the microporous element, e.g., due to the presence of microorganisms, may be subsequently removed by the carbon block element.

Thus, the subject disclosure is directed to a filter assembly for a filter cartridge, which includes a generally cylindrical carbon block filter element and a generally cylindrical pleated filter element disposed around the radially outer surface of the carbon block filter element. The filter assembly constructed according to the subject disclosure has an outlet communicating with the axial portion of the carbon block filter element, so that filtrate first passes through the pleated filter element, enters the carbon block filter element through its radially outer surface, propagates radially inwardly to the axial portion of the carbon block filter element and then along the axial portion of the carbon block filter element, and exits the axial portion of the carbon block filter element through the outlet.

The subject disclosure is also directed to a filter assembly for a filter cartridge, which includes a first filter element and a second filter element disposed around the radially outer surface of the first filter element. The filter assembly also has an outlet communicating with the first filter element, so that filtrate first passes through the second filter element, enters the first filter element through its radially outer surface, propagates radially inwardly to the axial portion of the first filter element and then along the axial portion of the first filter element, and exits the axial portion of the first filter element through the outlet. In this exemplary embodiment of the subject disclosure, the first filter element is fabricated from a material effective to absorb compounds imparting an undesirable odor or taste to the filtrate and the second filter element includes a pleated filter element that is effective to remove microorganisms from the filtrate.

In a filter assembly for a filter cartridge constructed according to the subject disclosure, the pleated filter element may comprise a membrane structure. The membrane structure may have an average pore size of between about 0.05 and about 5 microns and a thickness of between about 130 and about 300 microns. The membrane structures may include spiral-pleated membrane structures, radial pleated membrane structures, straight non-radial pleated membrane structures, membrane structures with pleats oriented orthogonally to the central axis, W-shaped multi-pleat structures (radial or spiral), modified W-shaped pleat structures and any number and/or combinations thereof. It may comprise a plurality of layers disposed atop one another, and these layers may have different filtering characteristics.

Preferably, the membrane structure has a gradient porosity construction. Such construction may include a plurality of layers having different average pore sizes. For example, in one embodiment of the subject disclosure, for any two adjacent layers, the average pore size of an upstream layer is no smaller than the average pore size of a downstream layer. More specifically, the membrane structure may comprise an upstream layer and a middle layer, both having average pore sizes of about 0.65 micron, and a downstream layer having the average pore size of about 0.2 micron.

The pleated element of the filter assembly constructed in accordance with the subject disclosure may further comprise a drainage layer located adjacent to the membrane structure. The drainage layer may support the membrane structure. In addition to a drainage layer, the pleated filter element may further comprise a cushioning layer disposed between the drainage layer and the membrane structure.

The filter assembly for a filter cartridge constructed in accordance with the subject disclosure may further comprise a prefilter disposed around the pleated filter element, so that the filtrate passes through the prefilter before passing through the pleated filter element. The prefilter may be made of polypropylene, polyester, polyamide, resin-bonded fibers, binder-free fibers, synthetics, sintered materials, metals, ceramics, yarns, special filter paper, polymer membranes, or any combination thereof. A protective netting may be disposed around the prefilter.

Additionally, the filter assembly constructed according to the subject disclosure may further comprise an upper end cap operatively associated with the upper end surface of the carbon block filter element, a lower end cap operatively associated with the lower end surface of the carbon block filter element, or both.

These and other aspects of the filter assembly of the subject invention, as well as of the cartridges configured for housing such filter assemblies, and the methods of using the same will become more readily apparent to those having ordinary skill in the art from the following detailed description hereinbelow.

### DESCRIPTION OF THE DRAWINGS

So that those having ordinary skill in the art to which the subject invention pertains will more readily understand how to make and use the subject invention, embodiments thereof will be described in detail hereinbelow with reference to the drawings, wherein:

FIG. 1 is an exploded perspective view of a filter assembly constructed in accordance with the subject disclosure;

FIG. 2 is an enlarged sectional view of an exemplary pleated filter element for use in the appropriate embodiments of the present disclosure, wherein the constituent layers are fanned out for illustration purposes;

FIG. 3 is an exploded perspective view of one embodiment of a filter cartridge housing an exemplary filter assembly constructed in accordance with the subject disclosure, with parts separated for ease of illustration;

FIG. 4 is a cross-sectional view of the filter cartridge shown in FIG. 3, wherein the direction of fluid flow through the filter cartridge is illustrated by arrows;

FIG. 5 is a cross-sectional view of an alternative embodiment of a filter cartridge housing an exemplary filter assembly constructed in accordance with the subject disclosure, wherein the direction of fluid flow through the filter cartridge is illustrated by arrows; and

FIG. 6 is a cross-sectional view of another alternative embodiment of a filter cartridge housing an exemplary filter assembly constructed in accordance with the subject disclosure, wherein the direction of fluid flow through the filter cartridge is illustrated by arrows.

### DETAILED DESCRIPTION OF THE INVENTION

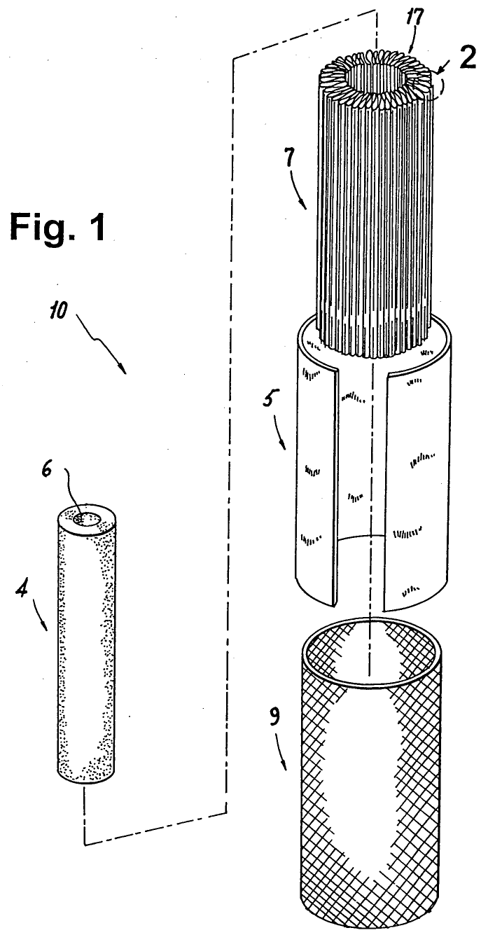

Referring now to the drawings, wherein like reference numerals identify similar structural elements of the filtration device described herein, there is illustrated in FIG. 1 an exemplary embodiment of a filter assembly constructed in accordance with the subject disclosure and designated generally by reference number 10. As shown in FIG. 1, the filter assembly 10 includes a generally cylindrical carbon block filter element 4 having an axial cavity 6, which may or may not extend therethrough. Such a carbon block filter element may be produced, for example, according to U.S. Pat. Nos. 5,928,588 and 5,882,517 to Wei-Chih Chen et al., both assigned to Cuno Incorporated, the disclosures of which are incorporated by reference herein.

As shown in FIG. 1, the filter assembly 10 further includes a generally cylindrical pleated filter element 7, disposed around the outer circumference of the carbon block element 4. Exemplary pleated filter elements 7 suitable for use in embodiments of the present disclosure are described in the U.S. Pat. No. 6,113,784 to Stoyell et al., assigned to Pall Corp., the disclosure of which is hereby incorporated by reference herein. Nonetheless, it will be understood by those of ordinary skill in the art that any suitable filtration medium can be employed in the embodiments of the present disclosure, depending on the fluid to be filtered, the desired filtering characteristics, and other relevant factors.

The pleated filter element 7 may include a membrane structure 17. Materials suitable for use as a part of the membrane structure 17 include a variety of polymeric materials having porous voids, such as cellulose acetate (CA), polysulfone (PSU), polyethersulfone (PESU), polyamide (PA), polyvinylidene fluoride (PVDF), polytetrafluoroethylene (PTFE), polycarbonate (PC), polypropylene (PP), and nylon. Pore sizes of materials included in the membrane structure 17 may range between about 0.05 and about 5 microns, depending on the particular requirements of the application. The thickness of the membrane structure 17 may range between about 130 and about 300 microns, while the thickness of the pleated filter element 7 may be much larger. It will be also understood by those of ordinary skill in the art that the subject disclosure encompasses the use of spiral-pleated membrane structures, radial pleated membrane structures, straight non-radial pleated membrane structures, membrane structures with pleats oriented orthogonally to the central axis, W-shaped multi-pleat structures (radial or spiral), modified W-shaped pleat structures and any number and/or combinations thereof.

The membrane structure 17 may consist of a single layer or include a plurality of layers of the same or different media disposed atop one another to a desired thickness. The membrane structure 17 may also include layers having different filtering characteristics. In a preferred embodiment, the membrane structure 17 has a gradient porosity construction. “Gradient porosity” means, in the context of the subject disclosure, that the average pore size in the membrane structure 17 varies as a function of depth into the membrane. For example, the membrane structure 17 may include discrete zones or layers having different average pore sizes.

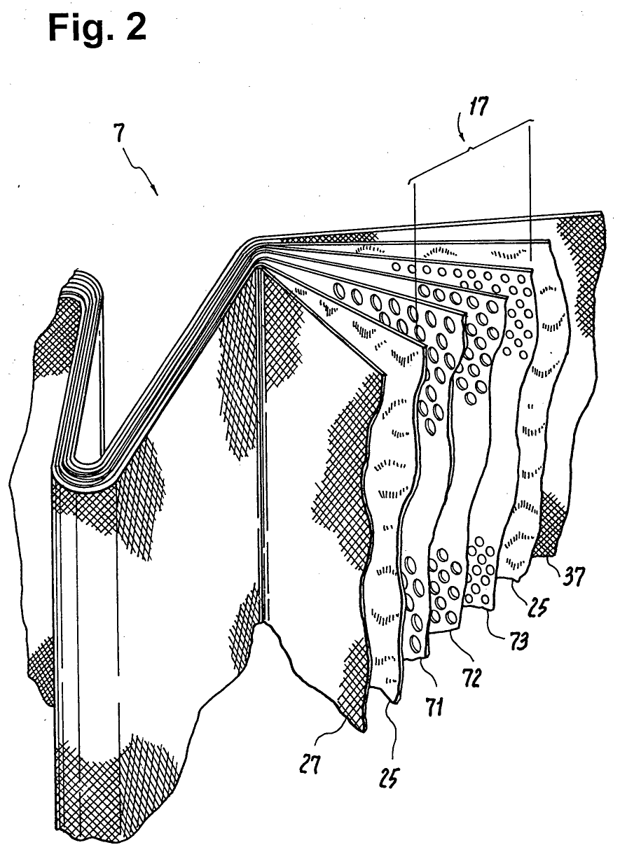

An exemplary membrane structure 17 of a gradient porosity construction is illustrated in FIG. 2, which represents a sectional view of the pleated filter element 7 with the constituent layers fanned out for illustration purposes. In this exemplary embodiment, the membrane structure 17 includes adjacent layers of media 71, 72 and 73, wherein the downstream layer 73 has a smaller average pore size than layers 71 and 72. The middle layer 72 may have the same or smaller average pore size than the upstream layer 71. In a preferred embodiment of the subject disclosure, the layers of media 71 and 72 have an average pore size rated at about 0.65 micron and the layer of media 73 has an average pore size rated at about 0.2 micron.

As shown in FIG. 2, the pleated filter element 7 may also include a drainage layer 27 upstream of the membrane element 17, a drainage layer 37 downstream of the membrane element 17, or both. One or both of the layers 27 and 37 may also have the additional functionality of supporting the membrane structure 7 and may be of the same or different construction and composition. On the other hand, some new polymeric materials, such as PSU, PESU, PVDF, and PTFE, may be advantageously pleated as a single- or multiple-layer membrane structure 17 without reinforcement. Preferably, layers 27 and 37 are distinct layers that are separate from the membrane structure 17 and can be in the form of a mesh, a screen, or a relatively coarsely porous woven or non-woven sheet. More preferably, the upstream layer 27 includes flexible sheeting of spun bounded polypropylene fibers and the downstream layer 37 includes plastic netting. Other suitable materials and structures known to those of ordinary skill in the art may also be used to manufacture the membrane structure 17 and the support layers 27 and 37, depending on the medium to be filtered, the temperature of the filtrate, and other factors.

The pleated filter element 7 may further include components other than the membrane structure 17 and the drainage layers 27, 37. For example, a cushioning layer 25 (or layers) may be placed between the membrane structure 17 and one or both of the drainage layers 27, 37. Such a cushioning layer or layers 25 may be included in the pleated filter element 7 in order to prevent abrasion of the membrane structure 17 due to its surface contact with the drainage layers 27 and 37, when the filter media expand and contract in response to pressure and/or temperature fluctuations of the fluid in the system in which the filter is used. The cushioning layer or layers 25 are preferably made of a material smoother than the drainage layers 27, 37 and having a higher resistance to abrasion than the media of the membrane structure 17.

The filter assembly 10 shown in FIG. 1 may also include a prefilter 5, made of any suitable material known to those of ordinary skill in the art, surrounding the outer circumference of the pleated filter element 7. Examples of prefilter materials include any suitable sheet-like fleeces of polypropylene, polyester, polyamide, resin-bonded or binder-free fibers (e.g., glass fibers), other synthetics (woven and non-woven fleece structures), sintered materials such as polyolefins, metals, ceramics, yarns, special filter paper (e.g., mixtures of fibers, cellulose, polyolefins, and binders), polymer membranes, and others. Preferably, the prefilter 5 is made of non-woven polypropylene (e.g., melt-blown) or non-woven polyester.

In addition to the prefilter 5, the filter assembly 10 may include a protective netting 9 disposed around the prefilter 5, e.g., for securing the prefilter 5 about the pleated filter element 7. The protective netting 9 can be made of any suitable material known to those of ordinary skill in the art, e.g., a polymer. For high temperature applications, a metallic mesh or screen may be used.

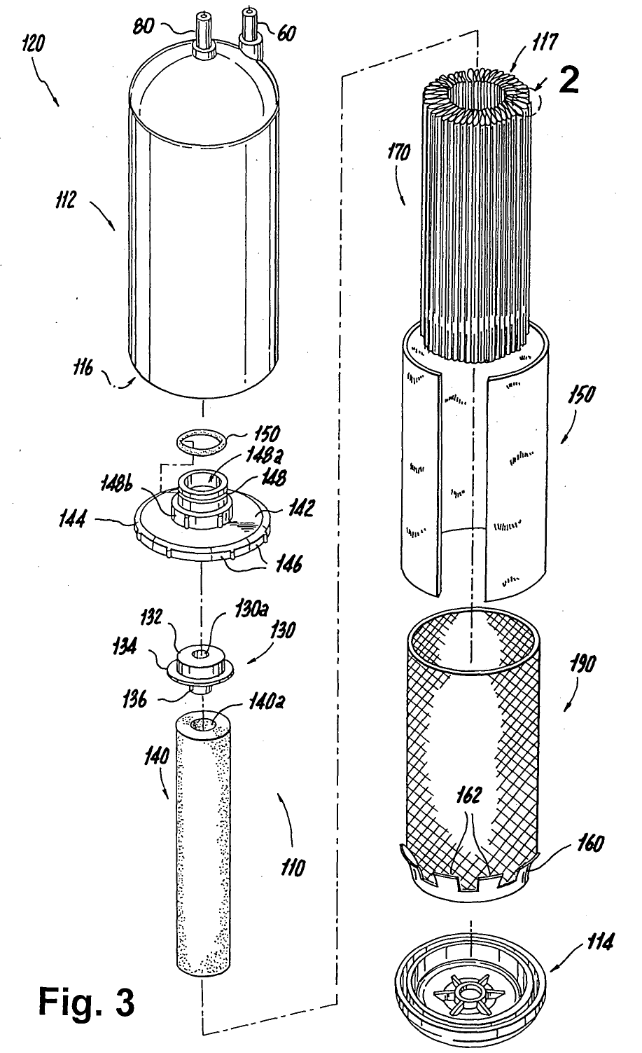

According to an exemplary embodiment illustrated in FIG. 3, the filter assembly 110 constructed in accordance with the subject disclosure may be included in a filter cartridge 120. The filter assembly 110 includes a carbon block element 140, a generally cylindrical filter element 170, prefilter 150, and protective netting 190. Other exemplary embodiments of the filter cartridge suitable for accommodating the filter assembly 110 are described in the U.S. application Ser. No. ______ entitled “Encapsulated Filter Cartridge,” filed on even date herewith, the disclosure of which is hereby incorporated by reference herein.

With further reference to FIG. 3, exemplary filter cartridge 120 includes a sump 112 having an interior chamber 116, configured to accommodate the filter assembly 110, and a closure cap 114 at the bottom end thereof for enclosing the filter assembly 110 within the sump 112. The closure cap 114 is preferably spun welded to the bottom end of the sump 112, but may also be attached by ultrasonic welding, hot plate welding, induction welding, or overmolding. The sump 112 has an inlet tube 60 for the ingress of fluid into the interior chamber 116 of the sump 112 and an outlet tube 80 for the egress of fluid from the interior chamber 116 at the top end of the sump.

Referring further to FIG. 3, an upper end cap 142 is operatively associated with the top end of the filter assembly 110. The upper end cap 142 preferably is configured to receive the upper end of the carbon block element 140 and the upper end of the pleated filter element 170. The upper end cap 142 may include a depending outer flange 144 having a plurality of circumferentially located and spaced apart flow channels 146 formed therein. In addition, the upper end cap 142 may include a stepped neck portion 148 having an axial bore 148a extending therethrough.

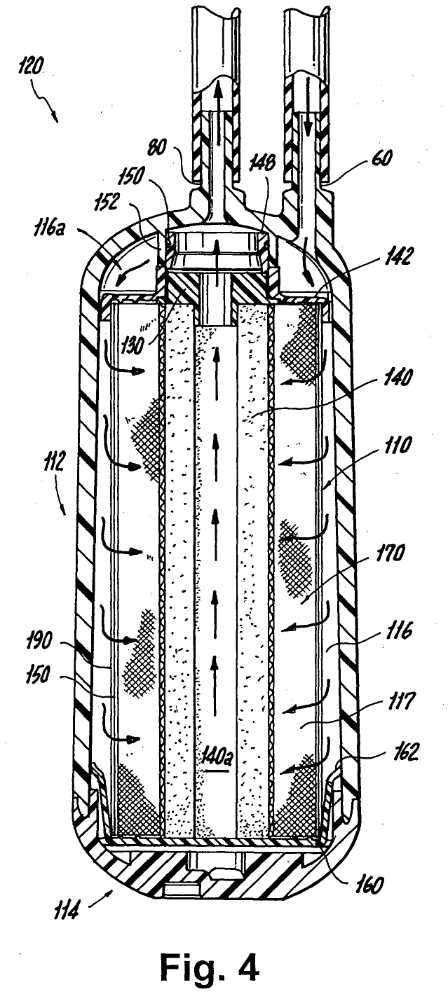

The exterior of the neck portion 148 may carry an annular sealing ring 150 positioned thereabout and dimensioned and configured for sealed engagement within an annular reception collar 152 (shown in FIG. 4), which may be located generally around the outlet tube 80 and project downwardly from the upper end of the interior chamber 116 of the sump 112. The sealed engagement of the neck portion 148 of the upper end cap 142 within the reception collar facilitates fluid communication between the axial cavity 140a in the carbon block element 140, the axial bore 148a extending through the upper end cap 142, and the central outlet tube 80 of the sump 112.

In addition, the exterior of the neck portion 148 may include a stepped portion 148b located below and spaced apart from the sealing ring 150 for facilitation of sealing engagement of the neck portion 148 by the reception collar 152. In an exemplary embodiment of the subject disclosure shown in FIG. 3, the filter assembly 110 may further include an adapter 130 having an axial bore 130a therethrough and operatively associated with the upper end of the carbon block element 140 and with the upper end cap 142 to further facilitate fluid communication between the axial cavity 140a in the carbon block element 140 and the outlet tube 80 of the sump 112. Preferably, the adapter has a first cylindrical portion 136, configured to fit within the axial cavity 140a of the carbon block element 140, a flange 134, and a second cylindrical portion 132 configured to fit within the upper end cap 142.

With continuing reference to FIG. 3, in some exemplary embodiments of the subject disclosure, a lower end cap 160 is operatively associated with the bottom end of the filter assembly 110. Preferably, the lower end cap 160 is configured to receive the lower end of the carbon block element 140 and the lower end of the pleated element 170 and may also be adapted and configured to support the filter assembly 110 within the sump 112. According to a preferred embodiment of the subject disclosure, the lower end cap 160 includes a plurality of circumferentially disposed outwardly flared fingers 162 for engaging the wall of the interior chamber 116 of the sump 112.

Referring now to FIG. 4, which has a set of arrows indicating the direction of the filtrate propagating through the filter cartridge 120, in an exemplary embodiment of the subject disclosure, unfiltered medium enters the upper region 116a of the interior chamber 116 of the sump 112 through the inlet tube 60. The unfiltered medium then propagates through the circumferentially located and spaced apart flow channels 146 (see FIG. 3) formed in the outer flange 144 of the upper end cap 142, and further into the lower portions of the interior chamber 116 of the sump 112. In the exemplary embodiments of the subject invention that include prefilter 150, the unfiltered media propagates first through the prefilter 150 before entering the pleated filter element 170. Upon passing through the constituent components of the pleated filter element 170, the filtrate propagates radially inwardly through the carbon block element 140 and into the axial cavity 140a. After travelling through the axial cavity 140a of the carbon block element 140 in the upward direction, and, in the appropriate exemplary embodiments, through the axial bore 130a of the adapter 130, the fluid exits the interior of filter cartridge 120 through the outlet tube 80.

The filter assembly 10 constructed in accordance with the subject disclosure as described above has various advantages over the prior art. For example, the filter assembly 10 has superior performance characteristics, such as capacity for effective removal of chemical contaminants, particulate matter and microorganisms while maintaining relatively long life time and relatively low pressure drop. The carbon block element 4,140 removes particulate matter and absorbs chemical contaminants, and the pleated filter element 7,170 removes microorganisms and particulate matter from the filtrate passing through the filter assembly 10.

Among other advantages of the filter assembly 10 having a pleated element 7 disposed upstream of the carbon block filter element 4 is its capability of retaining microorganisms before they can enter the carbon block element 4 where they can potentially grow, multiply and eventually colonize the filter cartridge. In addition, because in this embodiment the carbon block element 4 is located downstream of the pleated element 7, any undesirable odor or taste generated in the pleated element 7, e.g., due to the presence of microorganisms, may be subsequently removed by the carbon block element 4.

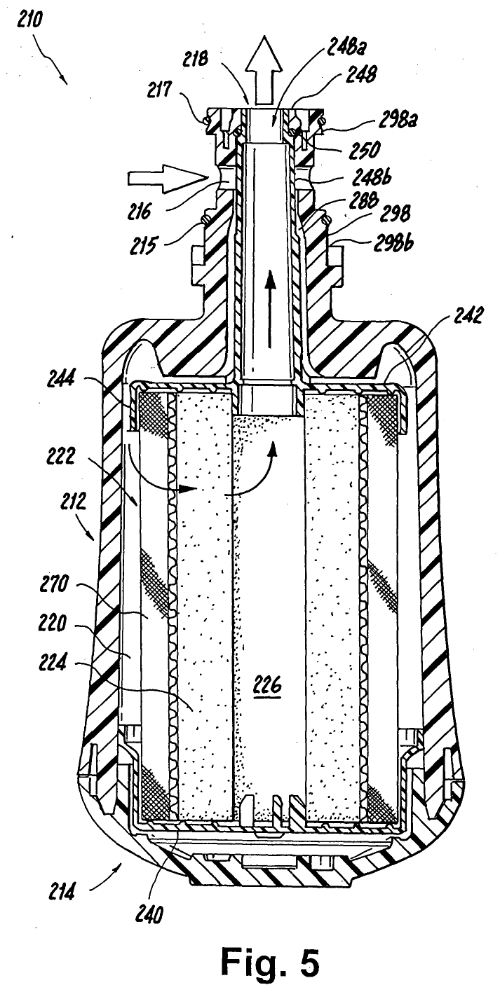

FIG. 5 shows a disposable encapsulated filter cartridge constructed in accordance with the subject disclosure and designated generally by reference numeral 210. As illustrated in FIG. 5, the filter cartridge 210 includes a sump 212 having an interior chamber 220 configured for supporting a filter assembly 222 and a closure cap 214 at the bottom end thereof for permanently enclosing the filter assembly 222 within the interior chamber 220 of the sump 212. The closure cap 214 is preferably spun welded to the bottom end of the sump 212. Other ways in which the closure cap 214 may be joined to the bottom end of the sump 212 may include ultrasonic welding, hot plate welding, induction welding, overmolding and mechanical securement means.

With continuing reference to FIG. 5, the sump 212 includes an elongated top portion 298 having a passage 288 extending therethrough and having an inlet 216 for the ingress of filtrate into the interior chamber 220 of the sump 212 and an outlet 218 for the egress of filtrate from the interior chamber 220 at the top end of the sump 212. The inlet 216 may be an opening in the radially outer surface of the elongated top portion 298, as illustrated in FIG. 5, that communicates with the passage 288. The passage 288 may include separate fluid flow channels in order to facilitate communication between the inlet 216 and the interior chamber 220 of the sump 212.

The outlet 218 is located at the top of the elongated top portion 298 and is generally aligned with the central axis of the sump 212. The inlet 216 and outlet 218 are preferably adapted and configured for mating with an appropriate port or module of an appliance, such as a water filtration appliance. Alternatively, the inlet 216 and outlet 218 may be adapted and configured for mating with an adapter, which, in turn, may be configured for mating with an appliance.

The elongated top portion 298 of the sump 212 may have stepped portions 298a and 298b and may also bear a sealing ring 217 disposed around the stepped portion 298a located above the inlet 216 and a sealing ring 215 disposed around the stepped portion 298b located below the inlet 216 to facilitate sealing engagement of the elongated top portion 298 with the appropriate portions of the appliance for which it is configured, or with the appropriate portions at an adapter, as will be understood by those of ordinary skill in the art.

Similar to exemplary embodiments of the subject disclosure shown in FIGS. 3 and 4, the filter assembly 222 of the encapsulated filter cartridge 210 includes a generally cylindrical pleated filter element 270 disposed around the outer circumference of a carbon block element 224. Both the carbon block filter element 224 and the pleated filter element 270 of this exemplary embodiment are substantially as described in detail above in reference to other embodiments of the subject disclosure. In addition, the filter assembly 222 may include any number and/or combination of elements described above in reference to other exemplary embodiments.

With continuing reference to FIG. 5, an upper end cap 242 is operatively associated with the upper end of the filter assembly 222. Preferably, the upper end cap 242 is configured to receive the upper end of the carbon block element 224 and the upper end of the pleated filter element 270. The upper end cap 242 may include a depending outer flange 244 having a plurality of circumferentially located and spaced apart fluid flow channels (see element 146 shown in FIG. 3) formed therein. In addition, the upper end cap may include a stepped neck portion 248 having a stepped portion 248b and an axial passage 248a extending therethrough. The stepped neck portion 248 is configured to be accommodated within the passage 288 of the elongated top portion 298 of the sump 212 and to allow the unfiltered medium entering the inlet 216 to pass into the lower regions of the interior chamber 220 of the sump 212 for communication with the radially outer surface of the filter assembly 222. The exterior of the neck portion 248 may carry an annular sealing ring 250 positioned thereabout above the stepped portion 248b and dimensioned and configured for sealed engagement within the passage 288 of in the elongated top portion 298 of the sump 212.

In the appropriate embodiments of the subject disclosure, a lower end cap 240 is operatively associated with the lower end of the filter assembly 222. Preferably, in this embodiment of the present disclosure, the lower end cap 240 is configured to receive the lower end of the carbon block element 224 and the lower end of the pleated element 270 and may also be adapted and configured to support the filter assembly 222 within the sump 212. Preferably, the lower end cap 240 has a structure similar to the lower and caps of exemplary embodiments shown in FIGS. 3 and 4 and described in detail above.

Referring further to FIG. 5, which has a set of arrows indicating the direction of the filtrate flow through the encapsulated filter cartridge 210, in operation, unfiltered medium enters through the inlet 216 in the elongated top portion 298 of the sump 212 into the region between the interior surface of the passage 288 and the outer surface of the stepped neck portion 248. In the appropriate embodiments of the subject disclosure, the unfiltered medium then propagates through the circumferentially located and spaced apart flow channels formed in the outer flange 244 of the upper end cap 242, and further into the lower portions of the interior chamber 220 of the sump 212.

The unfiltered medium then enters the radially outer surface of the filter assembly 222 and propagates radially inwardly into the axial cavity 226 of the carbon block filter element 224. After travelling along the axial cavity 226 of the carbon block element 224 in the upward direction, and, in the appropriate embodiments, through the axial passage 248a of the end cap 242, the filtered medium exits the interior of the filter cartridge 210 through the outlet 218.

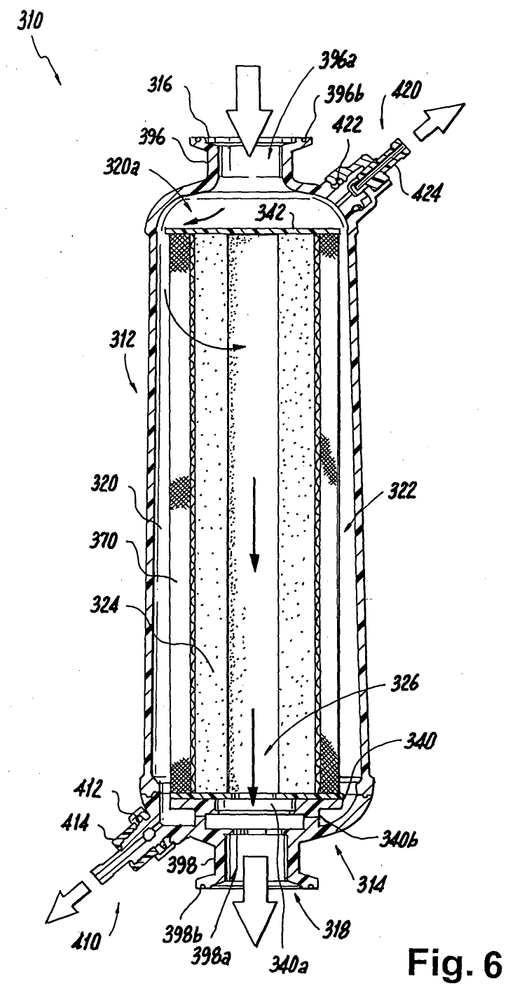

FIG. 6 shows another filter cartridge constructed in accordance with the subject disclosure and designated generally by reference numeral 310. As illustrated in FIG. 6, the filter cartridge 310 includes a sump 312 having an interior chamber 320 configured for supporting a filter assembly 322 and a closure cap 314 at the bottom end thereof for permanently enclosing the filter assembly 322 within the sump 312. The closure cap 314 is preferably spun welded to the bottom end of the sump 312. Other ways in which the closure cap 314 may be joined to the bottom end of the sump 312 may include ultrasonic welding, hot plate welding, induction welding and overmolding.

With continuing reference to FIG. 6, the sump 312 includes an elongated top portion 396 having an annular flange 396b and axial passage 396a extending therethrough and having an inlet 316 for the ingress of filtrate into the interior chamber 320 of the sump 312. According to this exemplary embodiment, the closure cap 314 includes an elongated portion 398 having an annular flange 398b and an axial passage 398a extending therethrough. An outlet 318 for the egress of filtered media from the interior chamber 320 may be located at the bottom end of the elongated portion 398 of the closure cap 314. The inlet 316 and the outlet 318 are generally aligned with the central axis of the sump 312. The inlet 316 is in communication with the radially outer surface of the filter assembly 322, while the outlet 318 is in communication with the axial cavity 326 of the carbon block element 324. The inlet and outlet 316 and 318 are preferably adapted and configured for mating with an appropriate port or module of an appliance, such as a water filtration appliance.

Similarly to previously described embodiments, the filter assembly 322 of the encapsulated filter cartridge 310 includes a generally cylindrical pleated filter element 370, disposed around the outer circumference of a carbon block element 324. Both the carbon block filter element 324 and the pleated filter element 370 of this exemplary embodiment are substantially as described in detail above in reference to other embodiments of the subject disclosure. In addition, the filter assembly 322 may include any number and/or combination of elements described above in reference to other exemplary embodiments.

With continuing reference to FIG. 6, an upper end cap 342 is operatively associated with the upper end of the filter assembly 322. Preferably, the upper end cap 342 is configured to receive and sealingly enclose the upper end of the carbon block element 324 and the upper end of the pleated filter element 370, so as to prevent filtrate from entering through the top surface of the filter assembly.

In the appropriate embodiments of the subject disclosure, a lower end cap 340 is operatively associated with the bottom end of the filter assembly 322. The lower end cap 340 has an axial passage 340a therethrough and a generally cylindrical portion 340a and preferably is configured to be secured to the closure cap 314. In addition, the lower end cap 340 preferably is configured to receive the lower end of the carbon block element 324 and the lower end of the pleated element 370 and is sealingly secured to the closure cap 314 to prevent the unfiltered medium from entering the stream of filtered medium passing through the axial passage 340a to the outlet 318. The ways of sealingly securing the cylindrical portion 340a to the closure cap 314 may include the use of an O-ring, welding and other structures and methods known to those of ordinary skill in the art.

Optionally, the sump 312 may include a vent 420 for venting air from the interior chamber 320 of the sump 312 upon the start-up of the filtering process. The vent 420 includes a vent cap 414 for selective opening of the vent 420 and a sealing ring 412 for sealing engagement of the vent cap 414. It will be understood by those of ordinary skill in the art that any structure may be used in place of the vent 420 that will perform a similar function.

Further, the sump 312 may optionally include a drain 410 for draining the interior chamber 320 of the sump 312 of the remaining filtrate prior to disposal of the filter cartridge. The drain 410 includes a drain cap 414 for selective opening of the drain 410 and a sealing ring 412 for sealing engagement of the drain cap 414. It will be understood by those of ordinary skill in the art that any structure may be used in place of the drain 410 that will perform a similar function.

Referring further to FIG. 6, which has a set of arrows indicating the direction of the filtrate flow through the encapsulated filter cartridge 310, in operation, unfiltered medium enters through the axial passage 396a into the upper region 320a of the interior chamber 320 of the sump 312. The unfiltered medium then enters the radially outer surface of the filter assembly 322 and propagates radially inwardly into the axial cavity 326 of the carbon block filter element 324. After travelling along the axial cavity 326 of the carbon block element 324 in the downward direction, through the axial passage 340a of the end cap 340, and then through the axial passage 398a, the filtered medium exits the interior chamber 320 of the filter cartridge 310 through the outlet 318.

Although the filter assemblies constructed in accordance with the subject disclosure have been described with respect to specific embodiments, those skilled in the art will readily appreciate that changes and modifications may be made thereto without departing from the spirit and scope of the present invention. For example, the filter assemblies constructed in accordance with the subject disclosure may be used for pressurized as well as for gravity-fed applications.

What is claimed is:

1. A filter assembly for a filter cartridge, comprising:
(a) a generally cylindrical carbon block filter element having a radially outer surface, an upper end surface, a lower end surface and an axial portion;
(b) a generally cylindrical pleated filter element disposed around the radially outer surface of the carbon block filter element; and
(c) an outlet communicating with the axial portion of the carbon block filter element, so that filtrate first passes through the pleated filter element, enters the carbon block filter element through its radially outer surface, propagates radially inwardly to the axial portion of the carbon block filter element and then along the axial portion of the carbon block filter element, and exits the axial portion of the carbon block filter element through the outlet.

2. A filter assembly as recited in claim 1, wherein the pleated filter element comprises a membrane structure.

3. A filter assembly as recited in claim 2, wherein the membrane structure has an average pore size of between about 0.05 and about 5 microns.

4. A filter assembly as recited in claim 2, wherein the membrane structure has a thickness of between about 130 and about 300 microns.

5. A filter assembly as recited in claim 2, wherein the membrane structure is selected from the group consisting of: a spiral-pleated membrane structure, a radial pleated membrane structure, a straight non-radial pleated membrane structure, a membrane structure with pleats oriented orthogonally to the central axis, a radial W-shaped multi-pleat structure, a spiral W-shaped multi-pleat structure, a modified W-shaped pleat structure and any combination thereof.

6. A filter assembly as recited in claim 2, wherein the membrane structure comprises a plurality of layers disposed atop one another.

7. A filter assembly as recited in claim 6, wherein at least two of the plurality of layers have different filtering characteristics.

8. A filter assembly as recited in claim 2, wherein the membrane structure has a gradient porosity construction.

9. A filter assembly as recited in claim 8, wherein the membrane structure includes a plurality of layers having different average pore sizes.

10. A filter assembly as recited in claim 9, wherein for any two adjacent layers the average pore size of an upstream layer is no smaller than the average pore size of a downstream layer.

11. A filter assembly as recited in claim 9, wherein the membrane structure comprises an upstream layer and a middle layer, both having average pore sizes of about 0.65 micron, and a downstream layer having the average pore size of about 0.2 micron.

12. A filter assembly as recited in claim 2, wherein the pleated filter element further comprises a drainage layer.

13. A filter assembly as recited in claim 12, wherein the drainage layer supports the membrane structure.

14. A filter assembly as recited in claim 12, wherein the pleated filter element further comprises a cushioning layer disposed between the drainage layer and the membrane structure.

15. A filter assembly as recited in claim 1, further comprising a prefilter disposed around the pleated filter element, whereby the filtrate passes through the prefilter before passing through the pleated filter element.

16. A filter assembly as recited in claim 15, wherein the prefilter is made substantially of a material selected from the group consisting of: polypropylene, polyester, polyamide, resin-bonded fibers, binder-free fibers, synthetics, sintered materials, metals, ceramics, yarns, special filter paper, polymer membranes, and any combination thereof.

17. A filter assembly as recited in claim 15, further comprising a protective netting disposed around the prefilter.

18. A filter assembly as recited in claim 1, further comprising an upper end cap operatively associated with the upper end surface of the carbon block filter element.

19. A filter assembly as recited in claim 1, further comprising a lower end cap operatively associated with the lower end surface of the carbon block filter element.

20. A filter assembly for a filter:cartridge, comprising:
(a) a first filter element having a radially outer surface, an upper end surface, a lower end surface and an axial portion;
(b) a second filter element disposed around the radially outer surface of the first filter element;
(c) an outlet communicating with the first filter element, so that filtrate first passes through the second filter element, enters the first filter element through its radially outer surface, propagates radially inwardly to the axial portion of the first filter element and then along the axial portion of the first filter element, and exits the axial portion of the first filter element through the outlet;
wherein said first filter element is fabricated from a material effective to absorb compounds imparting an undesirable odor or taste to the filtrate; and
wherein said second filter element includes a pleated filter element that is effective to remove microorganisms from the filtrate.

21. A filter assembly as recited in claim 20, wherein the first filter element is a carbon block filter element.

22. A filter assembly as recited in claim 20, wherein the pleated filter element comprises a membrane structure.

23. A filter assembly as recited in claim 22, wherein the membrane structure has an average pore size of between about 0.05 and about 5 microns.

24. A filter assembly as recited in claim 22, wherein the membrane structure has a thickness of between about 130 and about 300 microns.

25. A filter assembly as recited in claim 22, wherein the membrane structure is selected from the group consisting of: a spiral-pleated membrane structure, a laid-over pleated membrane structure, a membrane structure with pleats oriented orthogonally to the central axis W-shaped multi-pleat structure, and any combination thereof.

26. A filter assembly as recited in claim 22, wherein the membrane structure comprises a plurality of layers disposed atop one another.

27. A filter assembly as recited in claim 26, wherein at least two of the plurality of layers have different filtering characteristics.

28. A filter assembly as recited in claim 22, wherein the membrane structure has a gradient porosity construction.

29. A filter assembly as recited in claim 28, wherein the membrane structure includes a plurality of layers having different average pore sizes.

30. A filter assembly as recited in claim 29, wherein for any two adjacent layers the average pore size of an upstream layer is no smaller than the average pore size of a downstream layer.

31. A filter assembly as recited in claim 29, wherein the membrane structure comprises an upstream layer and a middle layer, both having average pore sizes of about 0.65 micron, and a downstream layer having the average pore size of about 0.2 micron.

32. A filter assembly as recited in claim 22, wherein the pleated filter element further comprises a drainage layer.

33. A filter assembly as recited in claim 32, wherein the drainage layer supports the membrane structure.

34. A filter assembly as recited in claim 32, wherein the pleated filter element further comprises a cushioning layer disposed between the drainage layer and the membrane structure.

35. A filter assembly as recited in claim 20, further comprising a prefilter disposed around the pleated filter element, whereby the filtrate passes through the prefilter before passing through the pleated filter element.

36. A filter assembly as recited in claim 35, wherein the prefilter is made substantially of a material selected from the group consisting of: polypropylene, polyester, polyamide, resin-bonded fibers, binder-free fibers, synthetics, sintered materials, metals, ceramics, yarns, special filter paper, polymer membranes, and any combination thereof.

37. A filter assembly as recited in claim 35, further comprising a protective netting disposed around the prefilter.

38. A filter assembly as recited in claim 20, further comprising an upper end cap operatively associated with the upper end surface of the carbon block filter element.

39. A filter assembly as recited in claim 20, further comprising a lower end cap operatively associated with the lower end surface of the carbon block filter element.
